(19) United States
(12) Patent Application Publication
(10) Pub. No.: US 2011/0065456 A1
(43) Pub. Date: Mar. 17, 2011

(54) CELLULAR DEVICE DEACTIVATION SYSTEM

(76) Inventors: Joseph P. Brennan, Doylestown, PA (US); Eyal Adi, Doylestown, PA (US); William C. Campbell, Doylestown, PA (US)

(21) Appl. No.: 12/764,089

(22) Filed: Apr. 20, 2010

Related U.S. Application Data
(60) Provisional application No. 61/171,053, filed on Apr. 20, 2009.

(51) Int. Cl. H04W 4/04

(52) U.S. Cl. 455/456.4

(57) ABSTRACT

In general, in one aspect, the disclosure describes a wireless device that is capable of linking to a vehicle via a close range antenna, such as a Bluetooth antenna. Once the wireless device is linked to the vehicle it can receive location data and determine the speed of the wireless device. If the speed exceeds a predefined threshold the wireless device may have its wireless communications deactivated. If the wireless device is utilizing a hands free device wireless communications may be permitted. The use of the link to the vehicle ensures that the wireless device will not be deactivated when, for example, it is used on a train. In addition, waiting to gather location data and determine speed until when the wireless device is associated with a vehicle will save battery life. The wireless device may have a speed determination scheme that takes into account GPS multipath.

### PRIORITY

This application claims the priority under 35 USC § 119 of Provisional Application 61/171,053 entitled “In Vehicle Device Disabler With Option for Vehicle Tracking” filed on Apr. 20, 2009 and having Joseph P. Brennan, Eyal Adi, and William C. Campbell as inventors. Application Ser. No. 61/171,053 is herein incorporated by reference in its entirety but is not prior art.

### BACKGROUND

The use of wireless devises such as cellular phones and personal digital assistants (PDAs) continues to grow. The wireless devices enable users to communicate with others via voice or text, access the Internet, and keep lists and/or schedules from almost any location. Users of wireless devices may use the devices even while they are operating vehicles including but not limited to cars, trucks, buses, trains, and boats. Using the devices while operating the vehicles may distract the user while the user is operating the vehicle. The distraction caused by the use of the wireless devices may result in accidents that result in property damage, injury and/or death to not only the operator of the vehicle but any passengers in the vehicle and other individuals or property that may come in contact with the vehicle.

Many states and locales have adopted rules regarding the use of wireless devices while operating a vehicle. The rules may range from banning the use of the devices while driving to restricting the use in some manner. The rules implemented have had limited success in reducing the use of wireless devices while operating vehicles.

Signal jammers could be utilized to prevent the use of wireless devices within the vehicles. However, the 1934 telecommunications act (47 U.C.S. 333) makes it illegal to willfully or maliciously interfere with or cause interference to any radio communications of any station licensed or authorized by or under this Act or operated by the United States Government. Furthermore, opponents would argue that the use of the jammers could possibly interfere with the communications of more than just the operator of the vehicle.

What is needed is a means for restricting the use of wireless devices in a vehicle that is not illegal and is limited to the operator of the vehicle.

### BRIEF DESCRIPTION OF THE DRAWINGS

The features and advantages of the various embodiments will become apparent from the following detailed description in which:

FIG. 1 illustrates a simplified block diagram of an example wireless device, according to one embodiment;

FIG. 2 illustrates an example high level flow chart of the operation of the deactivation program, according to one embodiment;

FIG. 3 illustrates a simple block diagram of the linkage between a wireless device and an in-vehicle device, according to one embodiment;

FIG. 4 illustrates a high level flow chart of the operation of an example deactivation program that may be utilized by the system of FIG. 3 where the wireless device initiates the linkage sequence, according to one embodiment;

FIG. 5 illustrates a high level flow chart of the operation of an example deactivation program that may be utilized by the system of FIG. 3 where the in-vehicle device initiates the linkage sequence, according to one embodiment; and

FIG. 6 illustrates an example truth table that may be utilized in determining when to deactivate communications, according to one embodiment.

### DETAILED DESCRIPTION

In order to prevent an individual from using a wireless device (e.g., cellular phones, personal digital assistants (PDAs)) while operating a vehicle, the wireless device may be capable of deactivating itself if it is determined that the device is in a moving vehicle. The determination of the whether the wireless device is in a moving vehicle may be based on the speed of the wireless device. If it is determined that the speed of the wireless device is above some predetermined threshold (e.g., 15 miles per hour) it may be assumed that the wireless device is in a moving vehicle and communications may be deactivated. Deactivated may mean preventing a user from being notified of incoming communications (e.g., calls, texts, emails) and may prevent a user from initiating outgoing communications. The manner in which the deactivation may be implemented will be discussed in more detail later.

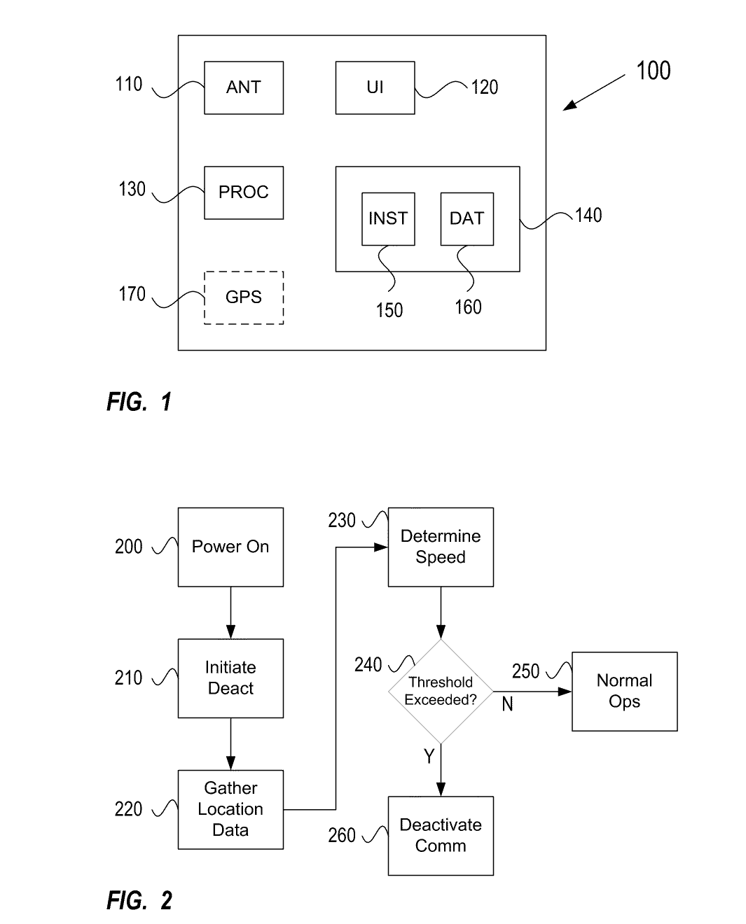

FIG. 1 illustrates a simplified block diagram of an example wireless device 100. The wireless device 100 may include an antenna 110, a user interface 120, a processor 130, and memory 140. The antenna 110 may be a network antenna to provide connectivity between the wireless device 100 and a wireless network (global system for mobile communications (GSM), code division multiplex access (CDMA), wideband CDMA (WCDMA), US and international frequency division duplex, time division duplex and code division duplex variants). The connectivity with the wireless network may enable wireless communications between the wireless device 100 and other entities and possibly other communication networks (e.g., public switched telephone network (PSTN)). The antenna 110 may also include other antennas for local communications, such as a Bluetooth antenna and/or a Wi-Fi antenna. If included in the device 100, these antennas may be used to connect to, for example, hands free devices and wireless routers.

The user interface 120 may provide one or more mediums (e.g., keyboard, display, touch screen, speaker, earpiece, microphone) for an operator to receive and enter communications via the wireless device 100. The processor 130 may control operations of the wireless device. The processor 130 may be one or more processors where each processor controls different aspects of the wireless device 100. The memory 140 may store processor executable instructions (e.g., programs) 150 and data (e.g., contacts, messages, configuration information) 160. The memory 140 may be a single memory device or may be multiple memory devices. The memory 140 may include non-volatile memory device for storing the programs 150 and a database for storing data 160.

The memory 140 and the programs stored therein may be accessed by the processor 130. The programs 150 may be executed by the processor 130 and cause the processor 130 to perform certain functions. The programs 150 may control basic operation of the wireless device 100 and may have been pre-stored in the memory 140 when the wireless device 100 was manufactured, assembled ad/or configured. The programs 150 may also be downloaded or loaded and stored in the memory 150 at any time. The programs 150 utilized by the wireless device 100 can perform any number of functions. For example, a program(s) may be capable of deactivating the wireless device 100 if it is determined that the wireless device is moving about a certain speed and therefore likely in a moving vehicle (hereinafter referred to as deactivation program).

The data 160 may be configuration data that is used by the programs 150 to set various features in the programs 150 or may be user data such as contacts, text messages, voice mail messages, and recorded messages to be played when the wireless device 100 is powered off or in use. The data 160 may be configuration data associated with the operation of different programs 150. For example, the configuration data may be associated with the deactivation program and may, for example, define the speed the wireless device 100 needs to be traveling in order to deactivate the wireless device 100 (hereinafter referred to as deactivation parameters).

The wireless device 100 may include a global positioning system (GPS) antenna 170 that can be used to obtain location coordinates from GPS satellites. The coordinates received from the GPS antenna 170 at defined intervals (e.g., every 5 seconds) may be provided to deactivation program to determine the speed that the wireless device 100 is traveling based thereon. The deactivation program 150 may compare the determined speed to a preset speed and if the preset speed is exceeded may deactivate the wireless device 100. The preset speed may be part of the deactivation parameters. The deactivation parameters may be entered or downloaded into the wireless device 100. Control of the deactivation parameters may be limited to an administrator (e.g., parent of teen-age kid, fleet manager) of the wireless device 100.

The deactivation of the wireless device 100 may include preventing communications from occurring. For incoming communications (e.g., calls, texts, emails), the deactivation may simulate the wireless device 100 being turned off, in use or the pressing of the ignore key so that phone calls are routed to an answering service and text messages are received and stored but not displayed. The wireless device 100 may provide the standard response a caller would receive if the wireless device 100 was in use, off or the ignore key was depressed, or it may provide a message related to the fact the wireless device 100 is in a moving vehicle and thus unavailable. The message related to the moving vehicle may be a standard message, may be one of several standard messages selected by the operator of the wireless device 100, or may be a message recorded by the operator of the wireless device 100. For incoming texts no response may be provided, as would be the case if the wireless device 100 was off or the wireless device 100 may provide a response that the operator of the wireless device 100 is in a moving vehicle. As with the incoming call the response to the sender may be standard, selected by the operator, or entered by the operator.

The operator of the wireless device 100 may not be aware that the incoming communication was received as it may be routed directly to an answering service or memory for later retrieval. Alternatively, the incoming communication may be briefly displayed before it is rerouted. For example, a quick audio and/or visual indication may be provided but the user may not be provided with the opportunity to pick up an incoming call or view and incoming text before it is rerouted. The rerouting may be accomplished by various means. For example, the deactivation program may simulate the wireless device 100 being turned off or being in use which may result in no indication provided to the user that a call or message was received. The deactivation program may simulate the ignore button on the wireless device 100 being activated as soon as the incoming communication is received which may result in a brief indication (e.g., audio, visual) that a call or message was received.

The deactivation parameters may identify certain parties that are permitted to have communications with the operator while the wireless device 100 is in a moving vehicle. For example, identification data (e.g., phone numbers, email addresses, contacts) for parties that are allowed communications with the wireless device 100 may be identified in the deactivation parameters. The allowed parties may be, for example, parents of teenage kids or a fleet manager. When an incoming communication is received by the wireless device 100, the deactivation program may check the identification of the incoming communication against the allowed parties identification and may deactivate the communication if the communication is not from an allowed party. If the communication is from an allowed party the deactivation program may allow the communication through. The entire communication may be allowed (e.g., user can take phone call and stay on phone as long as it may take, user may read entire text and possibly respond thereto).

Alternatively, the deactivation program may permit active communication for some small time frame (e.g., 1 minute). The small time frame may enable the allowed party to contact the user/driver to transmit any important information or get a status and then if further time was needed for communication the driver could pull over to continue communications in a safe manner. For example, if the parents of a teen driver wanted to ensure their child was on the way home the call would be allowed through so that the teen could let the parents known their location. If the parents and the teen needed to talk for a longer period the teen could pull over. The deactivation program may give a warning when the time frame is nearly complete (e.g., 15 second warning).

According to one embodiment, incoming communications from an allowed party may simply be an indication that the allowed party is attempting an incoming communication. The indication may be a particular audio or visual indication. If the user wants to communicate with the allowed party they can pull over and make a call or send a text message.

For outgoing communications (e.g., calls, texts, emails) the user interface (e.g., keyboard, touch screen) may be locked so that the operator may not enter a phone number or text message. According to one embodiment, the deactivation program may allow communications with emergency numbers (e.g., 911). The emergency phone calls may be enabled by either allowing certain numbers that are preprogrammed in the wireless device to be selected or enabling certain keys to be utilized (e.g., not locking the “9” and “1” keys) so that a user can dial 911. According to one embodiment, the deactivation program may be deactivated for some period of time (e.g., 1 hour) after an emergency call (911) is placed.

It should be noted that the wireless device 100 may include additional components, including but not limited to a power source (e.g., battery) that are not illustrated for ease of illustration and understanding.

FIG. 2 illustrates an example high level flow chart of the operation of the deactivation program. Initially the wireless device is powered on 200. The deactivation program is then initiated on the wireless device 210. It should be noted that the initiating may include configuring the initiation program with the deactivation parameters. As noted above the deactivation parameters may include configuration settings such as the speed limit with which deactivation will occur, a list of allowed parties, and time between obtaining location data in order to determine speed. The initiating may include activating the GPS antenna so that it retrieves location data at the defined intervals 220. Based on the location data received the speed can be determined 230. A determination is then made as to whether the determined speed exceeds the threshold speed (e.g., identified in the deactivation data) 240. If the threshold is not exceeded (240 No) then the deactivation program will allow the wireless device to communicate as normal (normal operations) 250. If the threshold is exceeded (240 Yes) then the deactivation program will deactivate communications for the wireless device 260. It should be noted that the deactivation program may enable incoming communications from allowed individuals and may enable outgoing communications for emergencies.

The deactivation program described above with respect to FIGS. 1 and 2 may base the decision of whether the wireless device is being used while operating a vehicle solely on the speed that the wireless device is moving. As such it is possible for the deactivation program to deactivate the wireless device if the user is on a train, bus, cab or some other vehicle that they are not operating. Deactivating the phone in such instances may not be desirable. In addition, in order to determine when the device is moving requires the GPS antenna to continually obtain location data which may cause a drain on the battery (substantially reduce battery life). Furthermore, the location of the wireless device in a vehicle (e.g., on a seat, in drivers purse) may result in interference with the GPS antenna and possibly missed or erroneous readings.

A potential solution to deactivating the wireless device when the wireless device is traveling above the defined speed but is not being used while the user is operating a vehicle (e.g., being used on a train) is to compare the location data to map data that may indicate, for example, roads, and railroad tracks. If the location is associated with a road the presumption would be that the wireless device was being used by the operator of a wireless vehicle and deactivation may continue. Alternatively, if the location is associated with a railroad track the presumption would be that the wireless device was being utilized on the train and the deactivation would not be implemented.

While comparing the location data to maps may prevent the deactivation from being implemented in some circumstances its implementation is limited. The limitation may be based on the accuracy of the location data and the map data as well as the fact that there may be railroads that run along highways and a determination as to whether you are on the highway or railroad may be difficult if not impossible. Accordingly, there may be times when the deactivation program is implemented when it shouldn't be and times when it is not implemented when it should be. Furthermore, comparing the location data to map data requires additional processing which will further drain the battery of the wireless device. In addition, not all wireless devices have GPS antenna's and/or map data which limits the wireless devices that the deactivation program may be implemented in. Moreover, it may be possible to disable the deactivation program by disabling the GPS antenna in the wireless device.

According to one embodiment, the vehicle may include a GPS antenna to gather location data and a Bluetooth antenna to communicate with the wireless device. The GPS antenna in the vehicle may be used to gather the location data. The GPS antenna in the car can be placed in the optimal location to work with the vehicle (e.g., on the hood, on the roof) and limit interference. The GPS antenna can then be linked to the wireless device to provide the location data to the wireless device. The wireless device can then use the location data to determine the speed of the vehicle and determine if communications for the wireless device should be deactivated. Using the GPS in the vehicle to gather location data may preserve the battery life of the wireless device as the wireless device will not need to continually use its GPS antenna to monitor location. Furthermore, requiring a linkage between the vehicle and the wireless device may prevent the false deactivations that may occur, for example, if the user was on a train.

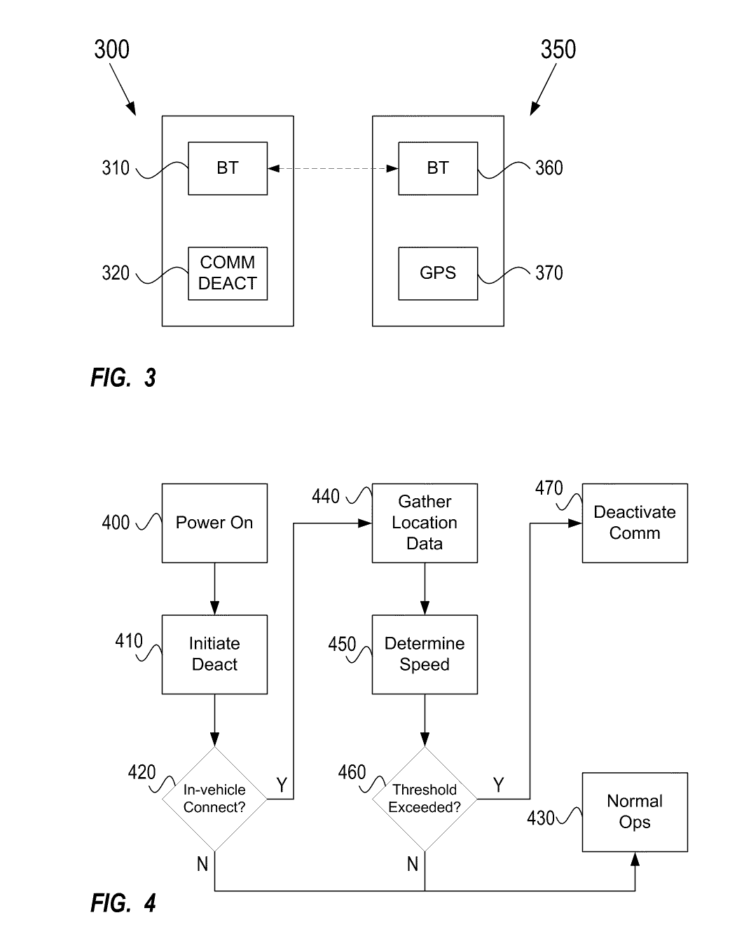

FIG. 3 illustrates a simple block diagram of the linkage between a wireless device 300 and an in-vehicle device 350. The wireless device 300 may include a Bluetooth antenna 310 and a communication deactivation program 320. The Bluetooth antenna 310 may be a class 1 Bluetooth receiver/transmitter that operates between 2.0 and 2.485 GHz and is fully programmed as a master device. The Bluetooth antenna 310 may communicate with slave Bluetooth devices (e.g., in-vehicle device, hands free devices) that it receives a signal for and that it has the code for. The code for the in-vehicle device 350 may be programmed into the wireless device 300 by an administrator (e.g., parent, fleet manager). The deactivation program 320 may deactivate the wireless device 300 if it is determined that the wireless device 300 is being used by an operator of a vehicle that is going over a predefined speed. The deactivation program 320 may determine the speed based on location data received from the in-vehicle device 350 via a Bluetooth link therebetween. It should be noted that the wireless device 300 would include additional components, including but not limited to, a processor, memory and a user interface that are not illustrated for ease of illustration and understanding. The deactivation program 320 may be stored in memory that may be accessed by the processor and when the program is executed by the processor causes the processor to take certain actions associated with determining if the wireless device should be deactivated and deactivating the wireless device if necessary.

The in-vehicle device 350 may include a Bluetooth antenna 360 and a GPS antenna 370. The Bluetooth antenna 360 may be for providing a communication link to the wireless device 300. The Bluetooth antenna 360 may be a class 1 Bluetooth receiver/transmitter that operates between 2.0 and 2.485 GHz and is fully programmed as a slave device. The Bluetooth antenna 360 may be identified by a code and any Bluetooth enabled device (master), such as the wireless device 300, wishing to communicate therewith needs to enter the code in order to link to the slave. As noted above, an administrator may ensure that the code for the in- vehicle device 350 is stored in the wireless device 300 to ensure the linkage between the devices will be complete. The Bluetooth antenna 360 may provide for synchronization/linking with the wireless device 300 through encrypted and secure protocols.

The GPS antenna 370 may retrieve location data from one or more GPS satellites at defined intervals. The location data may then be passed from the in-vehicle unit 350 to the wireless device 300 via the Bluetooth link therebetween. It should be noted that the in-vehicle device 350 would include additional components, for example a processor and memory, that are not illustrated for ease of illustration and understanding.

The in-vehicle device 350 may receive its power from the vehicle (e.g., connected to the vehicle battery). Alternatively, or in addition to as back-up power, the in-vehicle device 350 may receive its power from a battery, or other power sources (e.g., solar, wind). The in- vehicle device 350 may include a power converter to convert the power from the power source (e.g., vehicle, battery) to the appropriate voltage necessary to operate the device 350. The in- vehicle device 350 may communicate with the vehicle ignition and limit the application of power to the device 350 to when the vehicle ignition is activated (the vehicle is on). A user may not be able to power off or deactivate the in-vehicle device 350 in any manner.

FIG. 4 illustrates a high level flow chart of the operation of an example deactivation program that may be utilized by the system of FIG. 3 where the wireless device initiates the linkage sequence. Initially the wireless device is powered on 400. The deactivation program is then initiated on the wireless device 410. It should be noted that the initiating may include configuring the initiation program with the deactivation parameters (e.g., speed limit with which deactivation will occur, a list of allowed parties). A determination is made as to whether there is a connection with an in-vehicle device 420. The manner in which the determination may be made will be discussed in more detail later. If the determination is that there is not a connection with an in-vehicle device (420 No), the wireless device will operate under normal conditions (no deactivation) 430. If the determination is that there is a connection with an in-vehicle device (420 Yes), the location data may be received at defined intervals (e.g., every 4 seconds) from the in vehicle device 440. Based on the location data received the speed can be determined 450.

A determination is then made as to whether the determined speed exceeds the threshold speed that may be identified in the deactivation data (e.g., 15 miles/hour) 460. If the threshold is not exceeded (460 No) then the deactivation program will allow the wireless device to communicate as normal (normal operations) 430. If the threshold is exceeded (460 Yes) then the deactivation program will deactivate communications for the wireless device 470. It should be noted that the deactivation program may enable incoming communications from allowed individuals and may enable outgoing communications for emergencies.

Typically Bluetooth master devices (e.g., wireless device 300, Bluetooth antenna 310) are in listen or discover mode. That is, they do not actively search for Bluetooth slave devices (e.g., in-vehicle device 350, Bluetooth antenna 360) but rather listen for an indication from a Bluetooth slave device that it is available for connection. The Bluetooth slave devices may provide an indication that they are available when activated in some fashion. For example, a Bluetooth hands free ear piece (slave device) may include a button that a user can press that will cause the device to send out connection signals that may be received by a cellular phone (master). The cellular phone may detect the hands free device and ask for the code for the hands free device. If the user has the code they can enter the code in order to complete the linking of the cellular phone and hands free device. The cellular phone may maintain the code so that it need not be entered in the future to complete the linking of the devices.

As the in-vehicle device 350 may be located where the Bluetooth antenna 360 can not be activated to send out connection signals, the deactivation program 320 may instruct the Bluetooth antenna 310 to initiate signals that query whether there is an available slave device for connection at defined intervals (e.g., every minute). The query signals may be directed to the in-vehicle device 350. The query signals may check to see if the in-vehicle device 350 is available and if it receives an indication the in-vehicle device 350 is available it may then be asked for the code in order to link the devices. Alternatively the query signal may include the code within the message so that if the in-vehicle device 350 is available the linking immediately starts.

According to one embodiment, the Bluetooth antenna 360 may be capable of being activated to send out connection signals through other means then depressing a button on the device. For example, the Bluetooth antenna 360 may send out connection signals for a determined amount of time (e.g., 5 minutes) after when the vehicle is started or at defined intervals while the vehicle is operational (e.g., every minute). When the wireless device receives the connection signals it may initiate the linking sequence.

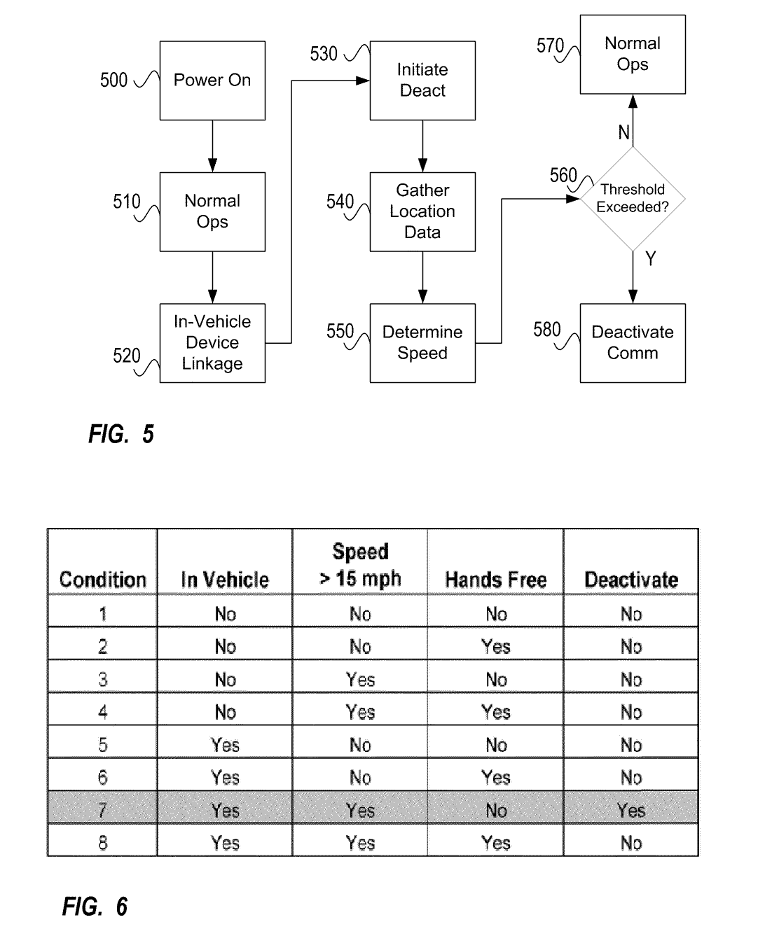

FIG. 5 illustrates a high level flow chart of the operation of an example deactivation program that may be utilized by the system of FIG. 3 where the wireless device initiates the linkage sequence. Initially the wireless device is powered on 500 and normal operations are initiated (the deactivation program is not activated) 510. During normal operations, the wireless device may receive connection signals from the in-vehicle device and then the linkage process may be initiated to link the devices two devices 520. After the devices are linked, the deactivation program is initiated on the wireless device 530. The wireless device may receive the location data from the in-vehicle device 540. The location data may be received at defined intervals (e.g., every 4 seconds). Based on the location data received the speed can be determined 550. A determination is then made as to whether the determined speed exceeds the threshold speed (e.g., identified in the deactivation data) 560. If the threshold is not exceeded (560 No) then the deactivation program will allow the wireless device to communicate as normal (normal operations) 570. If the threshold is exceeded (560 Yes) then the deactivation program will deactivate communications for the wireless device 580. It should be noted that the deactivation program may enable incoming communications from allowed individuals and may enable outgoing communications for emergencies.

The deactivation program may enable wireless communications that typically would be deactivated to occur if the wireless device is utilizing a hands free device (e.g., Bluetooth headset). If the wireless device is linked to another Bluetooth device associated with hands free communication the deactivation program may disable itself. For example, if it is determined that the wireless device is utilizing hand free communications the disabling program may cease receiving location data and calculating speed (e.g., 220, 230 of FIG. 2, 440, 450 of FIG. 4, 540, 550 of FIG. 5). Alternatively, if the wireless device is utilizing hand free communications the wireless device may stop attempting to establish a link with the in-vehicle device (e.g., 420 of FIG. 4, 520, 530 of FIG. 5). Furthermore, a determination as to whether the wireless device is linked to a hands free device may be made subsequent to the determination of the speed exceeding the threshold (e.g., 240 Yes of FIG. 2, 460 Yes of FIG. 4, 560 Yes of FIG. 5). Moreover, one determination will be made based on a plurality of parameters as to whether to deactivate communications.

FIG. 6 illustrates an example truth table that may be utilized in determining when to deactivate communications. The truth table includes states related to the parameters defined above (in-vehicle linkage, speed, and hands free communications) and defines when based on those states deactivation should occur. As illustrated, deactivation may be limited to when Bluetooth is linked with the in-vehicle device, the vehicle is going over 15 mph, and there is no hands free device linked (condition 7). The deactivation may be based on a single determination of the state of each of a plurality of parameters or may be based on multiple determinations each associated with a subset of the parameters where a certain determination results in wireless communications being allowed while another determination results in either further determinations being made or deactivation occurring. The implementation of deactivating wireless communications is in no way intended to be limited to the parameters or the states of the parameters defined in the truth table.

Utilizing the location data from the GPS antenna may result in false speed calculations that may be the result of GPS signal Multipath (multipath is one or more satellite signals being delayed in time since the signal is reflected by an object(s) and the reflected signal took a longer path before arriving at the receiver.). For example, a first signal may get delayed and this delay may result in a determination that the wireless device has not moved and thus has no speed when it fact in may be moving at a certain speed. Alternatively, a second signal may get delayed and this delay may make result in a determination that the device has traveled at a certain speed when in fact the device has not moved. These occurrences may result in wireless communications being deactivated while a user is stationary or allowing wireless communications while the user is operating a vehicle above the defined threshold. Such a situation is not desirable even if the condition is only temporary or intermittent.

The speed determination portion of the deactivation program may take multi-path into account. For example, the speed determination may compute the speed at a certain time and then compare it to previous speeds to determine if the speed change was reasonable and/or possible. For example, if a first speed determination is that the wireless device is not moving and then a second speed determination 4 seconds later is that the wireless device is traveling at 70 miles/hour the deactivation program may determine that the second determination can not reasonably be obtained and thus is invalid and discard it. Likewise, if the speed deceleration is not reasonable the speed determination may be discarded. That is, if the speed change is out of a defined range the result may be thrown out.

The deactivation program may determine an average speed based on a determined number of speed calculations that are not thrown out as invalid before the determined speed is compared to the threshold. For example, if the speed is determined every four seconds based on location data the determined speed may be the average of the last three valid speed calculations and that average may be compared to the threshold. Discarding out of band measurements and utilizing a rolling average may prevent false speed determinations that result in wireless communications being deactivated while a user is stationary as well as allowing wireless communications while the user is operating a vehicle above the defined threshold.

A wireless device user may attempt to bypass the deactivation program by disabling the Bluetooth antenna in the wireless device so that the linkage between the wireless device and the in-vehicle device will not occur and the location data will not be forwarded to the wireless device. The deactivation program may attempt to prevent this from occurring by impeding communications when this occurs. The impeding may consist of continuous messages that the Bluetooth antenna has been deactivated and requesting the user to reinitialize. It may also consist of notifying the administrator that the Bluetooth has been deactivated. Alternatively, the deactivation program may deactivate communications if the Bluetooth antenna is deactivated which would further restrict the user and prevent them from attempting this work around.

The deactivation program may enable the administrator to audit the usage of the wireless device. For privacy concerns the audit may be limited to parameters associated with the use of the wireless device in a vehicle including types of communications prevented/allowed, any attempts to get around the system, and any unusual situations. The administrator may also remotely audit the users wireless device for status (e.g., location, speed, state of wireless device). The deactivation program may automatically alert the administrator, for example via text or email, of various parameters, including for example configuration changes, permission changes, application start-up or reinstallation, external Bluetooth connection status, GPS connection status, calls terminated due to exceeding defined speed, and battery level.

The in-vehicle device has been described as a GPS antenna having and Bluetooth antenna for linking to the wireless device in order to provide location data thereto. The in-vehicle device may be an external navigation system utilized by the vehicle or may be an integrated navigation system, or may be a service such as On-star®.

The in-vehicle device need not provide location data to the wireless device. The in-vehicle device may calculate the speed of the vehicle and provide the speed to the wireless device. The speed may be based on GPS location data as previously discussed. Alternatively, the in-vehicle device may be connected to the vehicle computer and receive the speed information directly therefrom and provide the speed data to the wireless device.

Alternatively, the in-vehicle device may be in communication with a vehicle speed sensor (VSS) used to determine the speed of the vehicle. For example, most vehicles today are designed with a VSS encoder that counts 2 k, 4 k or 8 k pulses per mile. This VSS information is then fed into the on board computer for further processing of gear selection, fuel mixture, etc. Another form of a VSS is a hall effect pickup. The pickup can be installed after market on the drive shaft of the vehicle. The speed of each half revolution is detected and is then converted to speed.

The in-vehicle device may provide the VSS data to the wireless device and have the deactivation program calculate the speed based thereon or the in-vehicle device may calculate the speed from the VSS data and provide the speed to the wireless device.

The disclosure has focused on the in-vehicle device gathering data or determining speed and providing the data to the wireless device. According to one embodiment, the wireless device may gather the date (e.g., via a GPS antenna) but the implementation of the deactivation program may be restricted to when the wireless device is linked to the vehicle. Such an arrangement would ensure that communications were not deactivated when the wireless device was, for example, on a train and would also reserve battery life.

The disclosure focused on the use of Bluetooth linkage between the wireless device and the in-vehicle device but is not limited thereto. Rather any local wireless communication standard (e.g., WiFi) could be utilized without departing from the current scope.

The in-vehicle device may also include other devices that could be utilized. For example, the in-vehicle device could operate with a digital camera that could capture images associated with wireless communications.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A system to deactivate a wireless device from being utilized in a vehicle, comprising
a wireless device;
a linkage between the wireless device and a vehicle;
a processor; and
a processor readable storage medium contain processor implemented instructions that when executed by the processor cause the processor to link to the vehicle, determine the speed of the wireless device, and deactivate wireless communications.
